(19) United States
(12) Patent Application Publication
(10) Pub. No.: US 2013/0322396 A1
(43) Pub. Date: Dec. 5, 2013

(54) METHOD AND APPARATUS FOR COORDINATING INTERFERENCE ON USER EQUIPMENT

(71) Applicants: Lei Jiang, Beijing (CN); Ming Lei, Beijing (CN); Weidong Wang, Beijing (CN); Chaowei Wang, Beijing (CN)

(72) Inventors: Lei Jiang, Beijing (CN); Ming Lei, Beijing (CN); Weidong Wang, Beijing (CN); Chaowei Wang, Beijing (CN)

(73) Assignee: NEC (CHINA) CO., LTD., Beijing (CN)

(21) Appl. No.: 13/995,776

(22) PCT Filed: Sep. 19, 2011
(86) PCT No.: PCT/CN2011/079823

§ 371 Date: Aug. 23, 2013

(51) Int. Cl. H04W 16/14

(52) U.S. Cl. CPC H04W 16/14
USPC 370/329; 370/328

(57) ABSTRACT

Embodiments of the disclosure provide a method an apparatus for coordinating interference on a user equipment, the user equipment being served by a serving base station and interfered by an interfering base station. The method comprising steps of requesting for a limited access to the interfering base station; and responsive to an acknowledge message from the interfering base station, transmitting interference coordination information to the interfering base station.

### FIELD OF THE INVENTION

Embodiments of the present invention generally relate to communication techniques. More particularly, embodiments of the present invention relate to a method and apparatus for coordinating interference on a user equipment.

### BACKGROUND OF THE INVENTION

3GPP LTE and LTE-Advanced, also known as the evolution standard of the great success of GSM/HSPA technology, is aiming at creating a new series of specifications for the new evolving radio-access technology. One of its goals is to go on improving the communication system performance, such as the higher throughput. However, when a user equipment (UE) is served by its serving base station (BS), its throughput performance is often susceptible to the interference from the neighboring cells of one or more interfering base station.

To solve such a problem, many interference coordination schemes have been investigated. In an existing scheme, a UE served by a macro base station (MBS) is often called as a MUE, and a UE served by a home base station (HBS) is often called as a HUE. In the case that the MUE is interfered by the HBS, MUE checks its downlink interference by the increase of packet loss rate and packet; MUE checks the existence of nearby HBS by comparing the estimated RSRP of HBS; MUE sends to MBS interference coordination information; MBS sends the interfering HBS a message, which is named as MUE ARRIVAL by MME S1 interface or air interface; when the targeted HBS receives the message, the interfering HBS performs the following operations to mitigate the interference to MUE. Specifically, the HBS reallocates some of resource blocks (RBs) used by HUEs to the No-MUE spectrum part; reduces the RBs that are in MUE-possible part used for non-real-time traffics by HUEs; and reduce the RBs that are in MUE-possible part used for real-time traffics by HUEs if the QoS of HUEs is over qualified.

Comparing with the existing schemes, if the interference coordination information could be sent from the user equipment directly to the interfering base station, better performance and efficiency may be achieved. However, it is impossible for the existing schemes the user equipment to send the interference coordination information directly to the interfering base station.

### SUMMARY OF THE INVENTION

In view of the foregoing problems, there is a need to provide new methods and apparatuses for coordinating interference on a user equipment while the user equipment is served by a serving base station and interfered by an interfering base station.

According to a first aspect of the present invention, embodiments of the invention provide a method for coordinating interference on a user equipment, wherein the user equipment is served by a serving base station and interfered by an interfering base station. The method may comprise: requesting for a limited access to the interfering base station; and responsive to an acknowledge message from the interfering base station, transmitting interference coordination information to the interfering base station.

According to a second aspect of the present invention, embodiments of the invention provide a method for coordinating interference on a user equipment, wherein the user equipment is served by a serving base station and interfered by an interfering base station. The method may comprise steps of: responsive to requesting, by the user equipment, for a limited access to the interfering base station, sending an acknowledge message to the user equipment; and receiving interference coordination information from the user equipment to reallocate frequency resource.

According to a third aspect of the present invention, embodiments of the invention provide an apparatus for coordinating interference on a user equipment, wherein the user equipment is served by a serving base station and interfered by an interfering base station. The apparatus may comprise: requesting unit configured to request for a limited access to the interfering base station; and transmitting unit configured to, responsive to an acknowledge message from the interfering base station, transmit interference coordination information to the interfering base station.

According to a fourth aspect of the present invention, embodiments of the invention provide an apparatus for coordinating interference on a user equipment, wherein the user equipment is served by a serving base station and interfered by an interfering base station. The apparatus may comprise: sending unit configured to send an acknowledge message to the user equipment, responsive to requesting, by the user equipment, for a limited access to the interfering base station; and receiving unit configured to receive interference coordination information from the user equipment to reallocate frequency resource.

The following benefits can be expected with the invention. By means of sending the interference coordination information directly from the user equipment to the interfering base station, the invention can mitigate interference with less complexion and cost. Additionally, the invention may reuse the L1/L2 existing design of LTE, so a good reusability is achieved. Further, this invention can save PDCCH resource and time delay in the interference coordination.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where

FIG. 1 illustrates a schematic diagram of a communication environment applicable to embodiments of the present invention;

FIG. 2 illustrates a flow chart of a method for coordinating interference on a user equipment according to an embodiment of the invention;

FIG. 3 illustrates a flow chart of a method for coordinating interference on a user equipment according to another embodiment of the invention;

FIG. 4 illustrates a flow chart of a method for coordinating interference on a user equipment according to a further embodiment of the invention;

FIG. 5 illustrates a flow chart of a method for coordinating interference on a user equipment according to a still further embodiment of the invention;

FIG. 6 illustrates a block diagram of an apparatus for coordinating interference on a user equipment according to an embodiment of the invention;

FIG. 7 illustrates a block diagram of an apparatus for coordinating interference on a user equipment according to another embodiment of the invention;

FIG. 8 illustrates a block diagram of an apparatus for coordinating interference on a user equipment according to a further embodiment of the invention;

FIG. 9 illustrates a block diagram of an apparatus for coordinating interference on a user equipment according to a still further embodiment of the invention;

FIG. 10 illustrates a schematic diagram of a Physical Random Access Channel (PRACH) sequence according to an embodiment of the invention; and

FIG. 11 illustrates a schematic diagram of procedures for coordinating interference between a use equipment and an interfering base station according to an embodiment of the invention.

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

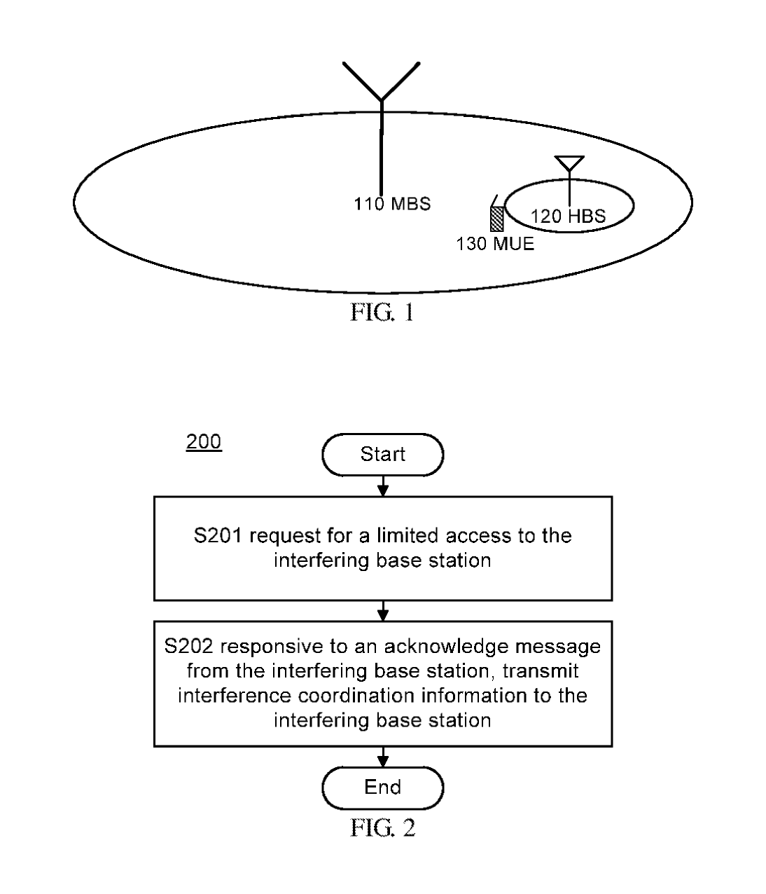

FIG. 1 illustrates a schematic diagram of a communication environment applicable to embodiments of the present invention.

The communication environment of FIG. 1 illustrates a LTE system. The system illustratively comprises two base stations (BSs), that is, a macro base station (MBS) 110 and a home base station (HBS) 120. A user equipment (UE) 130 is served by the MBS 110, so the UE 130 is denoted as MUE 130 and the MBS 110 is called as the serving base station in embodiments of the present invention. As shown in FIG. 1, although the MUE 130 is located in the cell of the MBS 110 and served by the MBS 110, the MUE 130 is liable to be interfered by the cell of the HBS 120 for several reasons, such as frequency resource conflict, strong transmitting power, and so on. So, the HBS 120 is called as the interfering base station in embodiments of the present invention.

For better understanding, the following embodiments of the present disclosure are described under the LTE system, for example, in the communication environment of FIG. 1. As can be appreciated by those skilled in the art, the present disclosure can be applicable to any other suitable communication environment, but not limited to the example shown in FIG. 1.

It is to be noted that, although FIG. 1 illustrates a MBS 110 as the serving base station and a HBS 120 as the interfering base station, the serving base station and the interfering base station according to embodiments of the present invention are not limited to a MBS and a HBS. In another embodiment of the present invention, a UE may be served by a MBS while being interfered by another MBS. That is, the serving base station is a MBS and the interfering base station is another MBS, where the service to the UE from the serving base station is interfered by the interfering base station. In this case, a switching threshold may be set for judging whether to switch to the cell of the interfering base station. If the interference exceeds the switching threshold, the UE may switch to the cell of the interfering bases station; and if not, the method for coordinating interference according to embodiments of the present invention may work, so as to reduce interference from the interfering base station on the UE.

It is further to be noted that, in the present invention, a “limited access” is a special random access. During a limited access to the interfering base station, after the UE successfully accesses the interfering base station, it communicates with the interfering base station while does not terminating the communication with the serving base station. In an example, after successfully accessing the interfering base station, the UE transmits interference coordination information to the interfering base station, and during the transmission of the interference coordination information, the UE may just pause communication with the serving base station rather than terminating this communication.

FIG. 2 illustrates a flow chart of a method 200 for coordinating interference on a user equipment according to an embodiment of the invention, wherein the user equipment is served by a serving base station and interfered by an interfering base station.

According to embodiments of the present invention, the method of FIG. 2 may be performed at a user equipment, for example, performed by an apparatus of the user equipment, by a processor of the user equipment, or by the user equipment itself. In embodiments of the present invention, the serving base station may be a macro base station, a micro base station or any other applicable network node. The interfering base station may be a small cell base station which has smaller size and lower transmit power, and works in the licensed frequency bands. The small cell base station may be a femto base station having a femto cell, a pico base station having a pico cell or any other applicable network node. The interfering base station may also be a macro base station or a micro base station. It is to be noted that the femto base station is sometimes called as home base station, HBS, home eNodeB, HeNB or something else which can be appreciated by those skilled in the art.

At step S201, a limited access to the interfering base station is requested for.

According to an embodiment of the present invention, during the process of requesting for a limited access to the interfering base station, access information for accessing the interfering base station may be first obtained, and then the limited access to the interfering base station may be requested for according to the obtained access information. There are may be several ways to obtain the access information. According to an embodiment of the present invention, the serving base station may involve in or not involve in the access information obtaining process. In an embodiment, access information for accessing the interfering base station may be obtained by sending an identifier of the interfering base station to the serving base station; and receiving the access information from the serving base station. In another embodiment, access information for accessing the interfering base station may be obtained by receiving messages on broadcast channel of the interfering base station; and obtaining the access information according to the received messages.

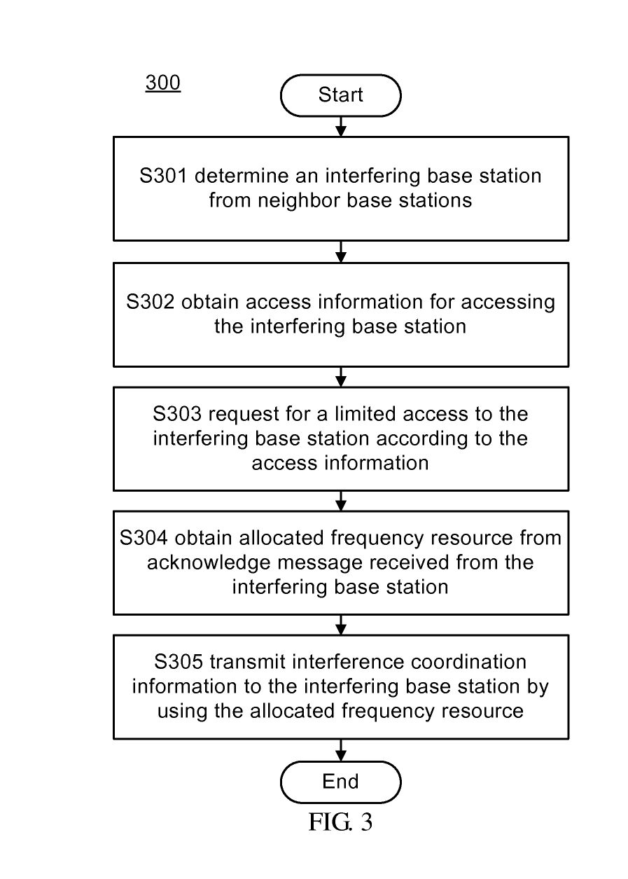

According to an embodiment of the present invention, when a user equipment requests for a limited access to the interfering base station, it may explicitly or implicitly indicate the access is a limited access or a normal random access. In an embodiment of the present invention, a sign of limited access may be added to a free subcarrier of Physical Random Access Channel (PRACH), to indicate whether an access is a limited access. Details about the sign will be described in detail with respect to FIG. 3.

At step S202, responsive to an acknowledge message from the interfering base station, interference coordination information is transmitted to the interfering base station.

According to an embodiment of the present invention, in response to the user equipment requests for a limited access to the interfering base station, the interfering base station may sending an acknowledge message to the user equipment to permit the access. In an embodiment of the present invention, the acknowledge message at least comprises information on the frequency resource allocated by the interfering base station.

According to an embodiment of the present invention, during step S202, the allocated frequency resource may be first obtained from the acknowledge message; and then the interference coordination information may be transmitted to the interfering base station by using the allocated frequency resource. The process of transmitting interference coordination information to the interfering base station by using the allocated frequency resource may comprise steps of: comparing the allocated frequency resource with the frequency resource currently used by the user equipment; if the allocated frequency resource is at least partially same as the frequency resource currently used by the user equipment, pausing communication with the serving base station and transmitting the interference coordination information in a low power; and if the allocated frequency resource is different from the frequency resource currently used by the user equipment, transmitting the interference coordination information in a low power.

According to an embodiment of the present invention, the interference coordination information at least indicates the frequency resource currently used by the user equipment.

According to a further embodiment of the present invention, the interfering base station may be first determined from neighbor base stations before requesting for a limited access to it.

FIG. 3 illustrates a flow chart of a method 300 for coordinating interference on a user equipment according to another embodiment of the invention, wherein the user equipment is served by a serving base station and interfered by an interfering base station.

According to embodiments of the present invention, the method of FIG. 3 may be performed at a user equipment, for example, performed by an apparatus of the user equipment, by a processor of the user equipment, or by the user equipment itself. According to embodiments of the present invention, the serving base station may be a macro base station, a micro base station or any other applicable network node; and the interfering base station may be a femto base station, a pico base station, a macro base station, a micro base station or any other applicable network node. In the embodiment of FIG. 3, the serving base station may be a macro base station illustrated as MBS 110 in FIG. 1; the interfering base station may be a home base station illustrated as HBS 120 in FIG. 1; and the user equipment may be the MUE 130 illustrated in FIG. 1.

At step S301, an interfering base station is determined from neighbor base stations.

There may be several ways to determine the interfering base station.

In an embodiment, reference signal receiving powers (RSRPs) of the neighbor base stations may be measured; the maximum RSRP may be obtained from the measured RSRPs; and then the neighbor base station corresponding to the maximum RSRP may be determined as the interfering base station.

In another embodiment, the determination of the interfering base station may be triggered by reference signal receiving quality (RSRQ) of the user equipment. Specifically, the user equipment may measure its RSRQ periodically or at predetermined instants, and once the user equipment detects the RSRQ is low, for example below a predefined threshold, the user equipment may select a base station with the maximum RSRP from the neighbor base stations as the interfering base station.

As appreciated by those skilled in the art, the interfering base station can be determined from neighbor base stations by other ways in the art, and the above embodiments are only for example, but not for limitation.

It is to be noted that the step S301 is optional. In embodiments of the present invention, the interfering base station may be predetermined before the method of the present invention begins.

At step S302, access information for accessing the interfering base station is obtained.

According to an embodiment of the present invention, the serving base station may involve in the access information obtaining process. Specifically, an identifier of the interfering base station may be sent to the serving base station and then the access information may be received from the serving base station.

According to an embodiment of the present invention, the serving base station does not involve in the access information obtaining process. Specifically, messages on broadcast channel of the interfering base station may be received first and then the access information may be obtained according to the received messages.

As appreciated by those skilled in the art, the access information can be obtained by other ways in the art, and the above embodiments are only for example, but not for limitation.

At step S303, a limited access to the interfering base station is requested for according to the access information.

According to an embodiment of the present invention, a sign of limited access is added to a free subcarrier of PRACH, to indicate whether an access is a limited access.

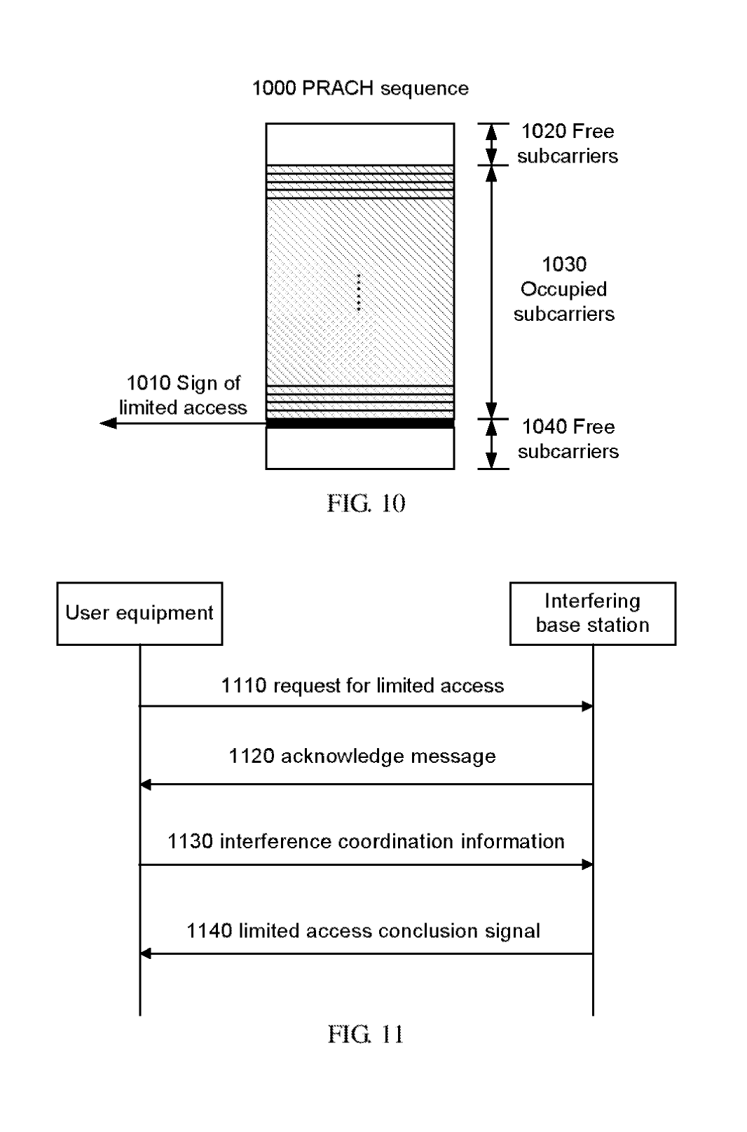

FIG. 10 illustrates a schematic diagram of a PRACH sequence 1000 according to an embodiment of the invention. In the embodiment, the user equipment (MUE 110) may launch a limited access request in PRACH according to parameters including random preamble indictor, transfer power, and so on. The sign 1010 of limited access is shown in FIG. 10.

In the embodiment of FIG. 10, the PRACH exemplarily includes 6 PRBs, that is, 864 subcarriers. The bandwidth of each subcarrier is 1.25 kHz. And 12 free subcarriers 1020 are put into the front of the PRACH sequence, a preamble sequence of 839 subcarriers 1030 are put into the middle of the sequence and another 13 free subcarrier 1040 are put into the back of the PRACH sequence. The sign of limited access may be added in one free subcarrier of PRACH to indicate the current access mode. For indicating the limited access, the sign may be set as “1” or any other predefined value capable of indicating the limited access. When the sign is set as “1” for example, it can be determined that the access mode is a limited access; otherwise, it is a normal access. Alternatively, the sign of limited access may be added in more free subcarriers of PRACH, and when all the sign is “1”, it can be determined that the access mode is a limited access.

At step S304, allocated frequency resource is obtained from acknowledge message received from the interfering base station.

According to embodiments of the present invention, when the user equipment detects that it is being interfered by an interfering base station other its serving base station, it requests for a limited access to the interfering base station. In response to the limited access request, the interfering base station may send an acknowledge message to the user equipment. In an embodiment, the acknowledge message at least comprises information on the frequency resource allocated by the interfering base station, wherein the frequency resource is allocated for uplink transmission from the user equipment to the interfering base station. Thus, in response to the acknowledge message, the user equipment can obtain the frequency resource allocated by the interfering base station.

It is to be noted that frequency resource may be in multiple forms, for example, one or more frequency bands, one or more resource blocks (RBs), one or more physical resource blocks (PRBs), and so on. In an embodiment of LTE system, the allocated frequency resource may comprise one or more PRBs, so the user equipment may know, from the acknowledge message, information of the allocated PRB, such as, the amount of the allocated PRBs, the position of the allocated PRB and so on.

According to embodiments of the present invention, besides the allocated frequency resource, the acknowledge message may further comprise clock information, so the user equipment may adjust its clock based on the clock information to align with the interfering base station.

At step S305, interference coordination information is transmitted to the interfering base station by using the allocated frequency resource.

According to an embodiment of the present invention, the interference coordination information may at least indicate the frequency resource currently used by the user equipment.

According to embodiments of the present invention, before transmitting the interference coordination information, the allocated frequency resource may be compared with the frequency resource currently used by the user equipment. If the allocated frequency resource is the same as, or partly same as the frequency resource currently used by the user equipment, communication with the serving base station may be paused and then the interference coordination information may be transmitted. If the allocated frequency resource is different from the frequency resource currently used by the user equipment, the interference coordination information may be transmitted.

According to embodiments of the present invention, the interference coordination information may be transmitted in a low power, which affects little to the communication between the user equipment and its serving nodes.

In the embodiment of FIG. 3, the user equipment (MUE 130) may send the interference coordination information to the interfering base station (HBS 120) through Physical Uplink Shared Channel (PUSCH). In another embodiment, the uplink transmission of MUE may be paused for a period. For example, the pause period may be more than 1 subframe (e.g., 1 ms). After the period, the user equipment may send the interference coordination information to the interfering base station with a lower-power.

According to an embodiment of the present invention, the interfering base station may send a limited access conclusion signal to the user equipment in response to the received interference coordination information, so the user equipment may receive the limited access conclusion signal. Based on the limited access conclusion signal, the user equipment may terminate the limited access.

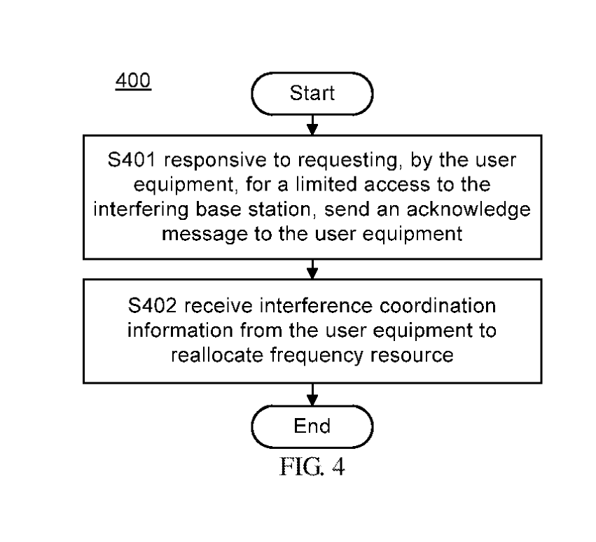

FIG. 4 illustrates a flow chart of a method 400 for coordinating interference on a user equipment according to a further embodiment of the invention, wherein the user equipment is served by a serving base station and interfered by an interfering base station.

According to embodiments of the present invention, the method of FIG. 4 may be performed at an interfering base station, for example, performed by an apparatus of the interfering base station, by a processor of the interfering base station, or by the interfering base station itself. In embodiments of the present invention, the serving base station may be a macro base station, a micro base station or any other applicable network node; and the interfering base station may be a femto base station, a pico base station, a macro base station, a micro base station or any other applicable network node.

At step S401, responsive to requesting, by the user equipment, for a limited access to the interfering base station, an acknowledge message is sent to the user equipment.

According to embodiments of the present invention, when the user equipment detects that it is being interfered by an interfering base station other its serving base station, it may request for a limited access to the interfering base station, which is similar as the limited access request in steps S201 and S303. For example, the user equipment may launch a limited access request in PRACH. Specifically, a sign 1010 of limited access may be added in the PRACH sequence, as shown in FIG. 10, to indicate whether the access is a limited access or a normal access. When received the PRACH sequence, the interfering base station may detect the sign of limited access so as to know the access is a limited access. In response to the limited access request, the interfering base station may send an acknowledge message to the user equipment.

According to embodiments of the present invention, the acknowledge message at least comprises information on the frequency resource allocated by the interfering base station. In embodiments of the present invention, the interfering base station may allocate the frequency resource by several existing means for uplink transmission from the user equipment to the interfering base station. The uplink transmission may be carried out on PUSCH or Physical Uplink Control Channel (PUCCH).

It is to be noted that frequency resource may be in multiple forms, for example, one or more frequency bands, one or more resource blocks (RBs), one or more physical resource blocks (PRBs), and so on.

According to embodiments of the present invention, besides the allocated frequency resource, the acknowledge message may further comprise clock information, so that the user equipment may adjust its clock based on the clock information to align with the interfering base station.

At step S402, interference coordination information is received from the user equipment to reallocate frequency resource.

According to an embodiment of the present invention, upon the use equipment receiving the acknowledge message sent at step S401, it may transmit the interference coordination information to the interfering base station. Thus, the interfering base station may receive the interference coordination information from the user equipment at step S402.

According to an embodiment of the present invention, the interference coordination information at least indicates the frequency resource currently used by the user equipment.

According to an embodiment of the present invention, the method of FIG. 4 further comprises steps of determining frequency resource interfering the user equipment based on the interference coordination information; and releasing the determined frequency resource for a period for reuse.

According to an embodiment of the present invention, the method of FIG. 4 further comprises steps of responsive to the received interference coordination information, sending a limited access conclusion signal to the user equipment.

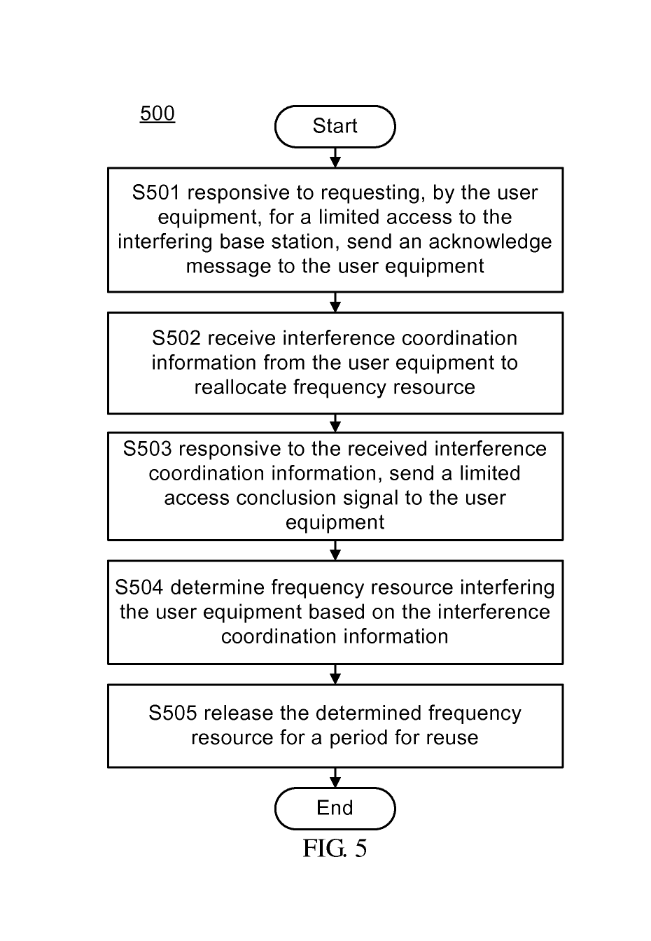

FIG. 5 illustrates a flow chart of a method 500 for coordinating interference on a user equipment according to a still further embodiment of the invention, wherein the user equipment is served by a serving base station and interfered by an interfering base station.

According to embodiments of the present invention, the method of FIG. 5 may be performed at an interfering base station, for example, performed by an apparatus of the interfering base station, by a processor of the interfering base station, or by the interfering base station itself. In embodiments of the present invention, the serving base station may be a macro base station, a micro base station or any other applicable network node; and the interfering base station may be a femto base station, a pico base station, a macro base station, a micro base station or any other applicable network node. In the embodiment of FIG. 5, for example, the serving base station may be a macro base station illustrated as MBS 110 in FIG. 1; the interfering base station may be a home base station illustrated as HBS 120 in FIG. 1; and the user equipment may be the MUE 130 illustrated in FIG. 1.

At step S501, an acknowledge message is sent to the user equipment responsive to requesting, by the user equipment, for a limited access to the interfering base station.

The step S501 is similar to the steps S401, so all the details described at the step S401 are also applicable to the step S501.

At step S502, interference coordination information is received from the user equipment to reallocate frequency resource.

The step S502 is similar to the steps S402, so all the details described at the step S402 are also applicable to the step S502.

At step S503, a limited access conclusion signal is sent to the user equipment responsive to the received interference coordination information.

According to an embodiment of the present invention, a conclusion signal may be sent to the user equipment in physical downlink control channel (PDCCH), so that the user equipment may terminate the limited access based on the limited access conclusion signal.

It is to be noted that step S503 is optional. Those skilled will understand that without a limited access conclusion signal, the method of the present invention is still applicable. For example, the limited access may be terminated automatically after the transmission of the interference coordination information, or after a period of time.

At step S504, frequency resource interfering the user equipment is determined based on the interference coordination information.

According to an embodiment of the present invention, the interference coordination information may at least indicate the frequency resource currently used by the user equipment. Since the frequency resource currently used by the user equipment may be also used by the interfering base station, this frequency resource may interfere the user equipment. So, the interfering base station may find the frequency resource which may interfere the user equipment and release it for a period. In an embodiment, the released frequency resource may be reused by the user equipment after the period.

As mentioned above, the frequency resource currently used by the user equipment may be one or more frequency bands, one or more resource blocks (RBs), one or more physical resource blocks (PRBs), and so on. In an embodiment of LTE system, interference coordination information may comprise information about one or more PRBs currently used by the user equipment. And based on the interference coordination information, the interfering base station may know the amount and position of the PRBs currently used by the user equipment.

At step S505, the determined frequency resource is released for a period for reuse.

According to an embodiment of the present application, the period may be determined several ways. For example, the period may be preset by those skilled in the art according to their experience, or may be determined according to concrete application. After the period, the frequency resource may be reused by the interfering base station.

It is to be noted that steps S504 and S505 are optional. The method of the present invention is still applicable without steps S504 and S505.

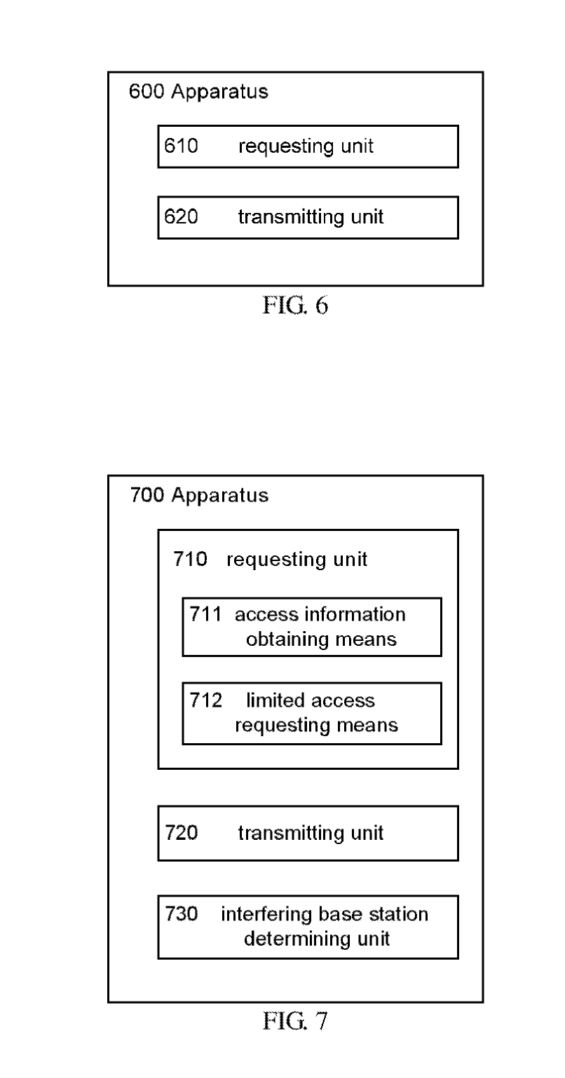

FIG. 6 illustrates a block diagram of an apparatus 600 for coordinating interference on a user equipment according to an embodiment of the invention. The user equipment is served by a serving base station and interfered by an interfering base station. The apparatus may be used in a UE.

In this embodiment, the apparatus 600 may comprise two components: requesting unit 610 and transmitting unit 620. The requesting unit 610 may be configured to request for a limited access to the interfering base station; and the transmitting unit 620 may be configured to, responsive to an acknowledge message from the interfering base station, transmit interference coordination information to the interfering base station.

FIG. 7 illustrates a block diagram of an apparatus 700 for coordinating interference on a user equipment according to another embodiment of the invention. The user equipment is served by a serving base station and interfered by an interfering base station. The apparatus may be used in a UE.

In this embodiment, the apparatus 700 may comprise three components: requesting unit 710, transmitting unit 720; and interfering base station determining unit 730. The requesting unit 710 may be configured to request for a limited access to the interfering base station; the transmitting unit 720 may be configured to, responsive to an acknowledge message from the interfering base station, transmit interference coordination information to the interfering base station; and the interfering base station determining unit 730 may be configured to determine the interfering base station from neighbor base stations.

In this embodiment, requesting unit 710 may include access information obtaining means 711 and limited access requesting means 712. According to an embodiment of the present invention, the access information obtaining means 711 may be configured to obtain access information for accessing the interfering base station; and the limited access requesting means 712 may be configured to request for a limited access to the interfering base station according to the access information.

According to an embodiment of the present invention, the access information obtaining means 711 may comprise: means configured to send an identifier of the interfering base station to the serving base station; and means configured to receive the access information from the serving base station.

According to an embodiment of the present invention, the access information obtaining means 711 may comprise: means configured to receive messages on broadcast channel of the interfering base station; and means configured to obtain the access information according to the received messages.

According to an embodiment of the present invention, the requesting unit 710 may comprise: means configured to add a sign of limited access to a free subcarrier of PRACH, to indicate whether an access is a limited access.

According to an embodiment of the present invention, the interference coordination information may at least indicate the frequency resource currently used by the user equipment.

According to an embodiment of the present invention, the transmitting unit 720 may comprise: means configured to obtain allocated frequency resource from the acknowledge message; and means configured to transmit interference coordination information to the interfering base station by using the allocated frequency resource.

According to an embodiment of the present invention, the means configured to transmit interference coordination information in the transmitting unit 720 may comprise: means configured to compare the allocated frequency resource with the frequency resource currently used by the user equipment; means configured to, if the allocated frequency resource is at least partially same as the frequency resource currently used by the user equipment, pause communication with the serving base station and transmit the interference coordination information in a low power; and means configured to, if the allocated frequency resource is different from the frequency resource currently used by the user equipment, transmit the interference coordination information in a low power.

According to an embodiment of the present invention, the interfering base station determining unit 730 may comprise: means configured to measure reference signal receiving powers (RSRPs) of the neighbor base stations; means configured to obtain the maximum RSRP from the measured RSRPs; and means configured to determine the neighbor base station corresponding to the maximum RSRP as the interfering base station.

It is noted that the apparatus 600 or 700 may be configured to implement functionalities as described with reference to FIGS. 2 and 3. Therefore, the features discussed with respect to methods 200 and 300 apply to the corresponding components of the apparatus 600 or 700. It is further noted that the components of the apparatus 600 or 700 may be embodied in hardware, software, firmware, and/or any combination thereof. For example, the components of the apparatus 600 or 700 may be respectively implemented by a circuit, a processor or any other appropriate selection device. Those skilled in the art will appreciate that the aforesaid examples are only for illustration not limitation.

In some embodiment of the present disclosure, the apparatus 600 or 700 comprises at least one processor. The at least one processor suitable for use with embodiments of the present disclosure may include, by way of example, both general and special purpose processors already known or developed in the future. The apparatus 600 or 700 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 600 or 700 to at least perform according to methods 200 or 300 as discussed above.

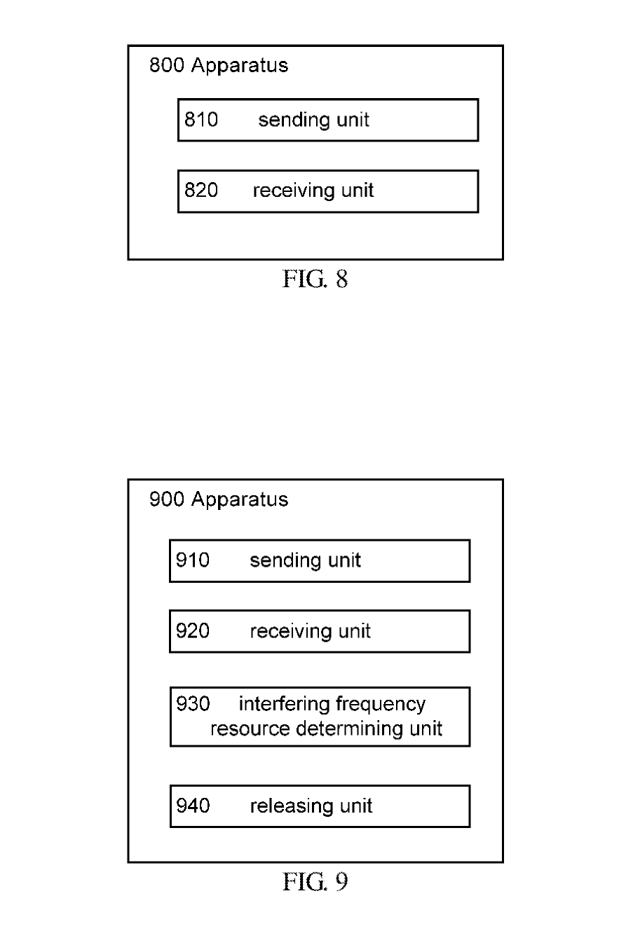

FIG. 8 illustrates a block diagram of an apparatus 800 for coordinating interference on a user equipment according to a further embodiment of the invention. The user equipment is served by a serving base station and interfered by an interfering base station. The apparatus may be used in a small cell base station (such as a home base station/femto base station, a pico base station, etc.), a macro base station, a micro base station or any other applicable network node.

In this embodiment, the apparatus 800 may comprise two components: sending unit 810 and receiving unit 820. The sending unit 810 may be configured to send an acknowledge message to the user equipment, responsive to requesting, by the user equipment, for a limited access to the interfering base station; and the receiving unit 820 may be configured to receive interference coordination information from the user equipment to reallocate frequency resource.

FIG. 9 illustrates a block diagram of an apparatus 900 for coordinating interference on a user equipment according to a still further embodiment of the invention. The user equipment is served by a serving base station and interfered by an interfering base station. The apparatus may be used in a small cell base station (such as a home base station/femto base station, a pico base station, etc.), a macro base station, a micro base station or any other applicable network node.

In this embodiment, the apparatus 900 may comprise four components: sending unit 910, receiving unit 920, interfering frequency resource determining unit 930 and releasing unit 940.

According to an embodiment of the present invention, the sending unit 910 may be configured to send an acknowledge message to the user equipment, responsive to requesting, by the user equipment, for a limited access to the interfering base station; the receiving unit 920 may be configured to receive interference coordination information from the user equipment to reallocate frequency resource. According to an embodiment of the present invention, the interfering frequency resource determining unit 930 may be configured to determine frequency resource interfering the user equipment based on the interference coordination information; and the releasing unit 940 may be configured to release the determined frequency resource for a period for reuse.

According to an embodiment of the present invention, the acknowledge message may at least comprising information on the frequency resource allocated by the interfering base station.

According to an embodiment of the present invention, the interference coordination information may at least indicate the frequency resource currently used by the user equipment.

According to an embodiment of the present invention, the sending unit 910 may be further configured to, responsive to the received interference coordination information, send a limited access conclusion signal to the user equipment.

It is noted that the apparatus 800 or 900 may be configured to implement functionalities as described with reference to FIGS. 4 and 5. Therefore, the features discussed with respect to methods 400 and 500 apply to the corresponding components of the apparatus 800 or 900. It is further noted that the components of the apparatus 800 or 900 may be embodied in hardware, software, firmware, and/or any combination thereof. For example, the components of the apparatus 800 or 900 may be respectively implemented by a circuit, a processor or any other appropriate selection device. Those skilled in the art will appreciate that the aforesaid examples are only for illustration not limitation.

In some embodiment of the present disclosure, the apparatus 800 or 900 comprises at least one processor. The at least one processor suitable for use with embodiments of the present disclosure may include, by way of example, both general and special purpose processors already known or developed in the future. The apparatus 800 or 900 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 800 or 900 to at least perform according to methods 400 or 500 as discussed above.

FIG. 11 illustrates a schematic diagram of procedures for coordinating interference between a use equipment and an interfering base station according to an embodiment of the invention.

In this embodiment, the serving base station may be a macro base station illustrated as MBS 110 in FIG. 1; the interfering base station may be a home base station illustrated as HBS 120 in FIG. 1; and the user equipment may be the MUE 130 illustrated in FIG. 1.

At operation 1110, the user equipment launches a limited access request in PRACH. The sign of limited access is added in a free subcarrier of PRACH. When the sign is “1”, it can be determined that the access mode is a limited access, not a normal access. At operation 1120, the interfering base station sends to the use equipment feedback message which includes clock adjustment and uplink PUSCH resource allocation. At operation 1130, in response to the feedback message, the use equipment adjusts its clock and transmits the interference coordination information through PUSCH to the interfering base station. At operation 1140, in response to the interference coordination information from MUE, the interfering base station sends a limited access conclusion signal to the use equipment in the PDCCH.

The above procedures illustrate a limited access scheme. By using the scheme, interference from the interfering base station to macro UE can be effectively mitigated.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in FIGS. 2-5 may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

1. A method for coordinating interference on a user equipment, the user equipment being served by a serving base station and interfered by an interfering base station, the method comprising:
requesting for a limited access to the interfering base station; and
responsive to an acknowledge message from the interfering base station, transmitting interference coordination information to the interfering base station.

2. The method of claim 1, wherein requesting for a limited access to the interfering base station comprises:
obtaining access information for accessing the interfering base station; and
requesting for a limited access to the interfering base station according to the access information.

3. The method of claim 2, wherein obtaining access information for accessing the interfering base station comprises:
sending an identifier of the interfering base station to the serving base station; and
receiving the access information from the serving base station.

4. The method of claim 2, wherein obtaining access information for accessing the interfering base station comprises:
receiving messages on broadcast channel of the interfering base station; and
obtaining the access information according to the received messages.

5. The method of claim 1, wherein requesting for a limited access to the interfering base station comprises:
adding a sign of limited access to a free subcarrier of Physical Random Access Channel (PRACH), to indicate whether an access is a limited access.

6. The method of claim 1, wherein the interference coordination information at least indicates the frequency resource currently used by the user equipment.

7. The method of claim 1, wherein responsive to an acknowledge message from the interfering base station, transmitting interference coordination information to the interfering base station comprises:
obtaining allocated frequency resource from the acknowledge message; and
transmitting interference coordination information to the interfering base station by using the allocated frequency resource.

8. The method of claim 7, wherein transmitting interference coordination information to the interfering base station by using the allocated frequency resource comprises:
comparing the allocated frequency resource with the frequency resource currently used by the user equipment;
if the allocated frequency resource is at least partially same as the frequency resource currently used by the user equipment, pausing communication with the serving base station and transmitting the interference coordination information in a low power; and
if the allocated frequency resource is different from the frequency resource currently used by the user equipment, transmitting the interference coordination information in a low power.

9. The method of claim 1, further comprising:
determining the interfering base station from neighbor base stations.

10. The method of claim 9, wherein determining the interfering base station from neighbor base stations comprises:
measuring reference signal receiving powers (RSRPs) of the neighbor base stations;
obtaining the maximum RSRP from the measured RSRPs; and
determining the neighbor base station corresponding to the maximum RSRP as the interfering base station.

11. A method for coordinating interference on a user equipment, the user equipment being served by a serving base station and interfered by an interfering base station, the method comprising:
responsive to requesting, by the user equipment, for a limited access to the interfering base station, sending an acknowledge message to the user equipment; and
receiving interference coordination information from the user equipment to reallocate frequency resource.

12. The method of claim 11, wherein the acknowledge message at least comprises information on the frequency resource allocated by the interfering base station.

13. (canceled)

14. The method of claim 11, further comprising:
determining frequency resource interfering the user equipment based on the interference coordination information; and
releasing the determined frequency resource for a period for reuse.

15. The method of claim 11, further comprising:
responsive to the received interference coordination information, sending a limited access conclusion signal to the user equipment.

16. An apparatus for coordinating interference on a user equipment, the user equipment being served by a serving base station and interfered by an interfering base station, the apparatus comprising:
requesting unit configured to request for a limited access to the interfering base station; and
transmitting unit configured to, responsive to an acknowledge message from the interfering base station, transmit interference coordination information to the interfering base station.

17. The apparatus of claim 16, wherein the requesting unit comprises:
access information obtaining means configured to obtain access information for accessing the interfering base station; and
limited access requesting means configured to request for a limited access to the interfering base station according to the access information.

18. The apparatus of claim 17, wherein the access information obtaining means comprises:
means configured to send an identifier of the interfering base station to the serving base station; and
means configured to receive the access information from the serving base station.

19. The apparatus of claim 17, wherein the access information obtaining means comprises:
means configured to receive messages on broadcast channel of the interfering base station; and
means configured to obtain the access information according to the received messages.

20. The apparatus of claim 16, wherein the requesting unit comprises:
means configured to add a sign of limited access to a free subcarrier of Physical Random Access Channel (PRACH), to indicate whether an access is a limited access.

21. (canceled)

22. The apparatus of claim 16, wherein the transmitting unit comprises:
means configured to obtain allocated frequency resource from the acknowledge message; and
means configured to transmit interference coordination information to the interfering base station by using the allocated frequency resource.

23. The apparatus of claim 22, wherein means configured to transmit interference coordination information to the interfering base station by using the allocated frequency resource comprises:
means configured to compare the allocated frequency resource with the frequency resource currently used by the user equipment;
means configured to, if the allocated frequency resource is at least partially same as the frequency resource currently used by the user equipment, pause communication with the serving base station and transmit the interference coordination information in a low power; and
means configured to, if the allocated frequency resource is different from the frequency resource currently used by the user equipment, transmit the interference coordination information in a low power.

24. The apparatus of claim 16, further comprising:
interfering base station determining unit configured to determine the interfering base station from neighbor base stations.

25. (canceled)

26. An apparatus for coordinating interference on a user equipment, the user equipment being served by a serving base station and interfered by an interfering base station, the apparatus comprising:
sending unit configured to send an acknowledge message to the user equipment, responsive to requesting, by the user equipment, for a limited access to the interfering base station; and
receiving unit configured to receive interference coordination information from the user equipment to reallocate frequency resource.

27. (canceled)

28. (canceled)

29. The apparatus of claim 26, further comprising:
interfering frequency resource determining unit configured to determine frequency resource interfering the user equipment based on the interference coordination information; and
releasing unit configured to release the determined frequency resource for a period for reuse.

30. The apparatus of claim 26, the sending unit is further configured to, responsive to the received interference coordination information, send a limited access conclusion signal to the user equipment.
